(19) United States
(12) Patent Application Publication
(10) Pub. No.: US 2026/0226269 A1
(43) Pub. Date: Aug. 6, 2026

(54) THERMOPLASTIC RESIN COMPOSITION

(71) Applicant: KANEKA CORPORATION, Osaka-shi (JP)

(72) Inventors: Takeshi SUGIYAMA, Settsu-shi (JP); Shun MURASAWA, Settsu-shi (JP); Arisa SONOYAMA, Settsu-shi (JP)

(73) Assignee: KANEKA CORPORATION, Osaka-shi (JP)

(21) Appl. No.: 19/634,366

(22) Filed: Mar. 31, 2026

Related U.S. Application Data
(63) Continuation of application No. PCT/JP2024/035548, filed on Oct. 4, 2024.

(30) Foreign Application Priority Data
Oct. 4, 2023 (JP) 2023-172667

(51) Int. Cl. C08L 67/02; C08J 5/18; C08K 3/34

(52) U.S. Cl. CPC C08L 67/02; C08J 5/18; C08K 3/34; C08J 2367/02; C08J 2467/02; C08J 2467/04; C08K 2201/005; C08L 2201/06; C08L 2205/03

(57) ABSTRACT

An object is to provide a thermoplastic resin composition capable of providing a molded product excellent in impact strength, and to provide a film molded product or sheet molded product excellent in impact strength. The above object is attained by providing a thermoplastic resin composition containing a thermoplastic resin (A), crosslinked resin particles (B) containing a polyhydroxyalkanoate-based resin and having a gel fraction of 50% or more, and an inorganic filler (C) in respective specific amounts, and a film molded product or sheet molded product formed by molding the thermoplastic resin composition and having a specific thickness and drop weight impact strength.

### TECHNICAL FIELD

The present invention relates to a thermoplastic resin composition.

### BACKGROUND ART

Plastic waste places a burden on the global environment, such as influence on ecosystems, generation of harmful gases during combustion, and global warming due to a large amount of combustion heat. As a material capable of solving this problem, development of biodegradable plastics has been actively pursued.

Patent Literature 1 discloses a thermoplastic resin composition which is capable of biodegradation and excellent in environmental compatibility, and which is obtained by blending 0.1 to 20 parts by weight of poly(3-hydroxyalkanoate) particles having an average particle size of 300 μm or less with respect to 100 parts by weight of poly(3-hydroxybutyrate-co-3-hydroxyhexanoate).

### CITATION LIST

### Patent Literature

[Patent Literature 1]
Japanese Patent Application Publication Tokukai No. 2004-161802

### SUMMARY OF INVENTION

### Technical Problem

However, the conventional technology as described above is not sufficient from the viewpoint of impact strength of a molded product of a thermoplastic resin composition, and there is room for further improvement.

An embodiment of the present invention is accomplished in view of the above current circumstances, and an object thereof is to provide a novel thermoplastic resin composition capable of providing a molded product excellent in impact strength, and to provide a film molded product or sheet molded product excellent in impact strength.

### Solution to Problem

As a result of diligent studies to attain the above object, the inventors of the present invention have completed an embodiment of the present invention.

A thermoplastic resin composition in accordance with an embodiment of the present invention contains: a thermoplastic resin (A) in an amount of 40.0 parts by weight to 98.0 parts by weight; crosslinked resin particles (B) in an amount of 1.0 part by weight to 15.0 parts by weight, the crosslinked resin particles (B) containing a polyhydroxyalkanoate-based resin and having a gel fraction of 50% or more; and an inorganic filler (C) in an amount of 1.0 part by weight to 50.0 parts by weight, where a total amount of the thermoplastic resin (A), the crosslinked resin particles (B), and the inorganic filler (C) is 100 parts by weight.

A film molded product or sheet molded product in accordance with an embodiment of the present invention is formed by molding a thermoplastic resin composition containing a thermoplastic resin (A) in an amount of 85.0 parts by weight to 99.0 parts by weight and crosslinked resin particles (B) in an amount of 1.0 part by weight to 15.0 parts by weight, the crosslinked resin particles (B) containing a polyhydroxyalkanoate-based resin and having a gel fraction of 50% or more, where a total amount of the thermoplastic resin (A) and the crosslinked resin particles (B) is 100 parts by weight, in which: the film molded product or sheet molded product has a thickness of 10 μm to 1000 μm; and the film molded product or sheet molded product has a drop weight impact strength of 150 mm or more.

### Advantageous Effects of Invention

According to an embodiment of the present invention, it is possible to provide a novel thermoplastic resin composition capable of providing a molded product excellent in impact strength, and to provide a film molded product or sheet molded product excellent in impact strength.

### DESCRIPTION OF EMBODIMENTS

The following description will discuss an embodiment of the present invention. Note, however, that the present invention is not limited thereto. The present invention is not limited to each configuration described below, and various modifications are possible within the scope shown in the claims. The present invention also encompasses, in its technical scope, any embodiment or example derived by combining technical means disclosed in differing embodiments and Examples. Further, it is possible to form a new technical feature by combining the technical means disclosed in the respective embodiments. All academic and patent documents cited in the present specification are incorporated herein by reference. Any numerical range expressed as “A to B” in the present specification means “not less than A and not more than B (i.e., a range from A to B which includes both A and B)” unless otherwise stated.

### [1. Thermoplastic Resin Composition]

A thermoplastic resin composition in accordance with an embodiment of the present invention contains: a thermoplastic resin (A) in an amount of 40.0 parts by weight to 98.0 parts by weight; crosslinked resin particles (B) in an amount of 1.0 part by weight to 15.0 parts by weight, the crosslinked resin particles (B) containing a polyhydroxyalkanoate-based resin and having a gel fraction of 50% or more; and an inorganic filler (C) in an amount of 1.0 part by weight to 50.0 parts by weight, where a total amount of the thermoplastic resin (A), the crosslinked resin particles (B), and the inorganic filler (C) is 100 parts by weight.

In the present specification, the “thermoplastic resin composition in accordance with an embodiment of the present invention” may be referred to as a “present resin composition”. The crosslinked resin particles (B) contained in the present resin composition can also be said to be crosslinked resin particles (B) in accordance with an embodiment of the present invention. In the present specification, the “crosslinked resin particles (B) in accordance with an embodiment of the present invention” may be referred to as “present crosslinked resin particles (B) “. In the present specification, the “film molded product or sheet molded product in accordance with an embodiment of the present invention” may be referred to as a “present film molded product or present sheet molded product”.

The present resin composition has an advantage of being capable of providing a molded product excellent in impact strength. In the present specification, the impact strength of the molded product can be evaluated based on a value of “drop weight impact strength (mm) “. A method for measuring the drop weight impact strength (mm) will be described in detail in Examples later.

According to a preferable embodiment of the present invention, the present resin composition also has an advantage of being capable of providing a molded product excellent in balance between strength and rigidity. The “strength” intends the above described “impact strength”. In the present specification, rigidity of a molded product can be evaluated based on a value of “tensile modulus (MPa) “. A method for measuring the tensile modulus (MPa) will be described in detail in Examples later.

The polyhydroxyalkanoate-based resin contained in the present crosslinked resin particles (B) is a biodegradable resin. Therefore, the present crosslinked resin particles (B) can have biodegradability. Since the present resin composition contains the crosslinked resin particles (B) which can have biodegradability, the present resin composition is advantageous from the viewpoint of biodegradability.

First, the following description will discuss the crosslinked resin particles (B).

### <Crosslinked Resin Particles (B)>

The crosslinked resin particles (B), that is, the present crosslinked resin particles (B), contain a polyhydroxyalkanoate-based resin and have a gel fraction of 50% or more. In the present specification, the “polyhydroxyalkanoate-based resin” may be referred to as “PHA”. By containing the present crosslinked resin particles (B), the present resin composition can provide a molded product excellent in impact strength. In other words, the present crosslinked resin particles (B) can be used as a modifier or an impact modifier for the thermoplastic resin (A).

### (PHA)

“PHA” is a generic term for polymers containing hydroxyalkanoic acid as a monomer unit (monomer repeating unit), and generally has biodegradability. PHA is aliphatic polyester, and is preferably polyester containing no aromatic ring. In the present specification, “PHA” intends a resin containing 50 mol % or more of a repeating unit of hydroxyalkanoic acid in all monomer repeating units (100 mol %). The PHA contains the hydroxyalkanoic acid repeating unit in an amount of preferably 60 mol % or more, more preferably 70 mol % or more, in all monomer repeating units (100 mol %).

The PHA is not particularly limited. Examples of the PHA include polyglycolic acid, a poly(3-hydroxyalkanoate)-based resin (hereinafter sometimes referred to as “P3HA”), poly(4-hydroxyalkanoate)-based resin, and the like. As the PHA, only one type may be used alone, or two or more types may be used in combination. The PHA preferably contains a poly(3-hydroxyalkanoate)-based resin, and more preferably is a poly(3-hydroxyalkanoate)-based resin (in other words, composed only of a poly(3-hydroxyalkanoate)-based resin). In the present specification, the “polyglycolic acid” intends a resin containing 50 mol % or more of a repeating unit represented by [—CH₂—CO—O-] in all monomer repeating units (100 mol %). The polyglycolic acid may contain the repeating unit represented by [—CH₂—CO—O-] in an amount of 60 mol % or more, 70 mol % or more, 80 mol % or more, or 90 mol % or more, in all monomer repeating units (100 mol %).

The polyglycolic acid may be a homopolymer of glycolic acid, or may be a copolymer of glycolic acid and a monomer other than glycolic acid (for example, a copolymer of glycolic acid and lactic acid, a copolymer of glycolic acid and caprolactone, or the like).

The polyglycolic acid can be obtained by a known method such as condensation polymerization of glycolic acid and ring-opening polymerization of glycolide.

The P3HA is polyhydroxyalkanoate containing, as an essential repeating unit, a 3-hydroxyalkanoic acid repeating unit represented by a formula [—CHR—CH₂—CO—O-] (where R is an alkyl group represented by CₙH₂ₙ₊₁, and n is an integer of 1 or more and 15 or less). In the present specification, “P3HA” intends a resin containing 50 mol % or more of the 3-hydroxyalkanoic acid repeating unit in all monomer repeating units (100 mol %). The P3HA contains the 3-hydroxyalkanoic acid repeating unit in an amount of preferably 60 mol % or more, more preferably 70 mol % or more, in all monomer repeating units (100 mol %).

The P3HA is not particularly limited, and may be a homopolymer containing the above described repeating unit or a copolymer containing the above described repeating unit. Examples of the copolymer include a copolymer of 3-hydroxybutanoic acid (hereinafter sometimes referred to as “3HB”) and one or more monomers selected from the group consisting of 3-hydroxypropionic acid, 3-hydroxypentanoic acid, 3-hydroxyhexanoic acid, 3-hydroxyheptanoic acid, 3-hydroxyoctanoic acid, 3-hydroxynonanoic acid, 3-hydroxydecanoic acid, 3-hydroxyundecanoic acid, 3-hydroxydodecanoic acid, 3-hydroxytridecanoic acid, 3-hydroxytetradecanoic acid, 3-hydroxyhexadecanoic acid, and 3-hydroxyoctadecanoic acid. Alternatively, other examples of the copolymer include a copolymer of 3HB and one or more monomers selected from the group consisting of 4-hydroxybutanoic acid, 4-hydroxypentanoic acid, 4-hydroxyhexanoic acid, 4-hydroxyheptanoic acid, 4-hydroxyoctanoic acid, 4-hydroxynonanoic acid, 4-hydroxydecanoic acid, 4-hydroxyundecanoic acid, 4-hydroxydodecanoic acid, 4-hydroxytridecanoic acid, 4-hydroxytetradecanoic acid, 4-hydroxyhexadecanoic acid, and 4-hydroxyoctadecanoic acid.

Examples of the P3HA include poly(3-hydroxybutyrate) (hereinafter sometimes referred to as “P3HB”) which is a homopolymer of 3HB, poly(3-hydroxybutyrate-co-3-hydroxyhexanoate) (hereinafter sometimes referred to as “P3HB3HH”), poly(3-hydroxybutyrate-co-4-hydroxybutyrate) (hereinafter sometimes referred to as “P3HB4HB”), and the like. As the P3HA, only one type may be used, or two or more types may be used in combination. In the present specification, “poly(X-co-Y)” is a copolymer containing an X repeating unit and a Y repeating unit, and intends a copolymer obtained by copolymerizing a monomer from which the X repeating unit is derived and a monomer from which the Y repeating unit is derived. During production of P3HA by microorganisms, a trace amount (approximately 1 mol % or less) of a monomer may be copolymerized. In a case where such a monomer does not significantly affect physical properties of the obtained P3HA, the monomer is regarded as not being copolymerized, and the P3HA is referred to by a name not including the monomer.

P3HA can be produced by microorganisms. Such microorganism-produced P3HA is typically P3HA composed only of D-form (R-form) 3-hydroxyalkanoic acid repeating units. Among the microorganism-produced P3HA, P3HB, P3HB3HH, and P3HB4HB are preferable, P3HB3HH and P3HB4HB easy are more preferable, from the viewpoint of industrial production.

It is also preferable that the P3HA contains a 3-hydroxybutanoic acid (3HB) repeating unit. In a case where the P3HA contains the t 3HB repeating unit, a compositional ratio of the 3HB repeating unit in all monomer repeating units (100 mol %) is preferably 60 mol % to 99 molo, more preferably 61 mol % to 97 mol %, further preferably 62 mol % to 95 mol %, from the viewpoint of a balance between flexibility and strength. In a case where the compositional ratio of the 3HB repeating unit in the P3HA is 60 mol % or more, there is an advantage that rigidity of the crosslinked resin particles (B) can be further improved. Meanwhile, in a case where the compositional ratio of the 3HB repeating unit in the P3HA is 99 mol % or less, there is an advantage that flexibility of the crosslinked resin particles (B) tends to be further improved. The monomer compositional ratio of the P3HA can be measured by gas chromatography or the like (see, for example, International Publication No. WO 2014/020838). As the P3HA, two or more types having different compositional ratios of the 3HB repeating unit may be used in combination.

A microorganism that produces P3HA is not particularly limited, provided that the microorganism is capable of producing P3HA. For example, Bacillus megaterium was first discovered in 1925 as a P3HB-producing bacterium. Other examples of the P3HB-producing bacterium are known as natural microorganisms such as Cupriavidus necator (formerly classified as Alcaligenes eutrophus, Ralstonia eutropha), and Alcaligenes latus. P3HB is accumulated in bacterial cells of these microorganisms.

Known examples of a bacterium that produces a copolymer of 3HB and another hydroxyalkanoic acid include Aeromonas caviae, which is a P3HB3HH-producing bacterium, Alcaligenes eutrophus, which is a poly(3-hydroxybutyrate-co-4-hydroxybutyrate)-producing bacterium, and the like. In particular, in order to increase productivity of P3HB3HH, Alcaligenes eutrophus AC32 strain (Alcaligenes eutrophus AC32, FERM BP-6038) (T. Fukui, Y. Doi, J. Bacteriol., 179, p 4821-4830 (1997)) into which genes of a group of P3HA synthases have been introduced is preferable. Microorganism bacterial cells obtained by culturing these microorganisms under appropriate conditions and accumulating P3HA in bacterial cells of the microorganisms are used. Besides the above examples, in accordance with P3HA that is desired to be produced, a genetically modified microorganism into which various P3HA synthesis-related genes have been introduced may be used, and/or culture conditions including a type of substrate may be optimized.

A weight-average molecular weight of the PHA is not particularly limited. The weight-average molecular weight of the PHA is preferably 50,000 to 3,000,000, preferably 100,000 to 2,000,000, more preferably 150,000 to 1, 500,000. In a case where the weight-average molecular weight of the PHA is 50,000 or more, there is an advantage that a tendency for the strength of the crosslinked resin particles (B) to decrease can be reduced or avoided. Additionally/alternatively, in a case where the weight-average molecular weight of the PHA is 50,000 or more, there is an advantage that a tendency to be sticky due to low molecular weight components can be reduced or avoided. Meanwhile, PHA having a weight-average molecular weight of 3,000,000 or less may have an advantage that production of PHA is easy and/or an advantage that the PHA is easy to handle in order to attain the object of an embodiment of the present invention. The numerical value of the weight-average molecular weight of the PHA is a value obtained by measurement using PHA before crosslinking treatment.

The measurement of the weight-average molecular weight can be carried out using gel permeation chromatography (GPC) (“High Performance Liquid Chromatograph 20A System” manufactured by Shimadzu Corporation), using a polystyrene gel (“K-G 4A”, “K-806M”, or the like manufactured by Showa Denko K.K.) for a column, and using chloroform as a mobile phase. The weight-average molecular weight can be determined as a molecular weight in terms of polystyrene using a calibration curve obtained by measuring polystyrene having a known molecular weight by the same measurement method. At this time, the calibration curve can be created using polystyrenes having weight-average molecular weights of 31,400, 197,000, 668,000, and 1,920,000. As the column in the GPC, a column suitable for measuring the molecular weight may be used.

### (Gel Fraction)

In the present specification, the “crosslinked resin particles” intend particles having a crosslinked structure in which molecular chains of a resin constituting the resin particles are bonded to each other intramolecularly and/or intermolecularly. That is, the present crosslinked resin particles (B) can have a crosslinked structure in which molecular chains of PHA are bonded to each other. An amount of the crosslinked structure in the crosslinked resin particles (B) affects the gel fraction of the crosslinked resin particles (B), and specifically, as the amount of the crosslinked structure increases, the gel fraction becomes higher. The present crosslinked resin particles (B) have a certain amount or more of a crosslinked structure, and therefore the present crosslinked resin particles (B) exhibit a high gel fraction, specifically, a gel fraction of 50% or more. In a case where the gel fraction of the present crosslinked resin particles (B) is 50% or more, the crosslinked resin particles (B) have excellent hardness, heat resistance, and solvent resistance.

The value of the gel fraction is preferably 60% or more, more preferably 70% or more, further preferably 75% or more, and particularly preferably 80% or more. Further, the value of the gel fraction may be 85% or more, or may be 90% or more. The upper limit of the gel fraction is not particularly limited, and only needs to be 100% or less. From the viewpoint of production efficiency of the crosslinked resin particles (B), the upper limit of the gel fraction is preferably 99.5% or less, and more preferably 99% or less. Further, the upper limit of the gel fraction may be 98% or less, may be 97% or less, or may be 96% or less.

The gel fraction is a value measured as follows:
(1) a dried product of the crosslinked resin particles (B) is added to chloroform so as to have a concentration of 0.7% by weight, and the obtained mixture is maintained at 60° C. for 30 minutes to obtain a chloroform solution;
(2) subsequently, the chloroform solution is left to stand still at room temperature for 3 hours, and then the chloroform solution is filtered through a membrane filter having a pore size of 0.45 μm; and
(3) the gel remaining on the filter is dried, the weight of the dried gel is measured together with the filter, and the gel fraction s calculated by the following formula.

$$Formula : Gel fraction ( \% ) = \{ ( weight of filter including dry get - weight of filter only ) / weight of dried product of crosslinked resin particles ( B ) used for measurement \} \times 100 ( \% ) .$$

### (Volume-Average Particle Size)

The volume-average particle size of the present crosslinked resin particles (B) is preferably 0.10 μm to 10.00 μm. According to this configuration, the crosslinked resin particles (B) can be suitably used for various applications as described later. The lower limit of the volume-average particle size is more preferably 0.15 μm or more, further preferably 0.20 μm or more, from the viewpoint of practical use opportunities. Further, the upper limit of the volume-average particle size is more preferably 8.00 μm or less, further preferably 5.00 μm or less, from the viewpoint of productivity (production and/or crosslinking treatment of PHA, and the like).

In the present specification, the volume-average particle size (MV) of the crosslinked resin particles (B) is a value obtained by measurement using an aqueous dispersion in which the crosslinked resin particles (B) are dispersed in an aqueous medium. More specifically, the volume-average particle size (MV) of the crosslinked resin particles (B) is a value calculated by a formula (1), that is, a formula (2) below, where particle sizes of individual crosslinked resin particles (B) included in a population of a total of k crosslinked resin particles are defined as d1, d2, . . . di . . . dk from the smallest, and volumes of the individual crosslinked resin particles (B) are defined as V1, V2, Vi . . . Vk (here, a volume of a crosslinked resin particle having a particle size di is defined as Vi).

$$MV = \frac{V 1 \cdot d 1 + V 2 \cdot d 2 + … Vi \cdot di + … Vk \cdot dk}{V 1 + V 2 + … Vi + … Vk} \qquad ( 1 )$$

$$MV = \frac{\sum ( Vi \cdot di )}{\sum ( Vi )} \qquad ( 2 )$$

As a measuring device for the particle size and volume of the crosslinked resin particles (B) in the aqueous dispersion, a general-purpose measuring device can be used, and examples of such a device include Microtrac MT3300EXII manufactured by Nikkiso Co., Ltd. In the present specification, the volume-average particle size of uncrosslinked resin particles can be measured by replacing “crosslinked resin particles” with “uncrosslinked resin particles” in the above method.

### (Peroxide)

The crosslinked structure in the present crosslinked particles (B) is not particularly limited, and is preferably a structure crosslinked using a peroxide. That is, the present crosslinked resin particles (B) are preferably crosslinked using a peroxide. In a case where a peroxide is used, radicals generated by decomposition of the peroxide act on molecules of a resin (for example, PHA) constituting the resin particles. Thereby, a crosslinked structure can be formed by direct bonding between molecular chains of the resin constituting the resin particles.

In a case where the crosslinked resin particles (B) are crosslinked using a peroxide, the aqueous dispersion containing the crosslinked resin particles (B) may contain a substance (a decomposition product of the peroxide, an unreacted peroxide, or the like) derived from the peroxide used for introducing the crosslinked structure. Alternatively, in a case where the crosslinked resin particles (B) are crosslinked using a peroxide, a substance (a decomposition product of the peroxide, an unreacted peroxide, or the like) derived from the peroxide used for introducing the crosslinked structure may adhere to the surface of the obtained crosslinked resin particles (B) or the like. That is, in a case where the present crosslinked resin particles (B) are crosslinked using a peroxide, the present crosslinked resin particles (B) or the present resin composition contain may a substance (a decomposition product of the peroxide, an unreacted peroxide, or the like) derived from the peroxide. In a case where the present crosslinked resin particles (B) or the present resin composition contains a substance derived from a peroxide, it can be found by analyzing the crosslinked resin particles (B) or the resin composition that the crosslinked resin particles (B) are crosslinked using a peroxide.

The peroxide may be an organic peroxide or an inorganic peroxide. The peroxide is preferably an organic peroxide because the gel fraction can be increased more efficiently.

As the organic peroxide, it is preferable to use at least one selected from the group consisting of diacyl peroxide, alkyl peroxy ester, dialkyl peroxide, hydroperoxide, peroxy ketal, peroxy carbonate, and peroxy dicarbonate, in consideration of a heating temperature, time, and/or the like during crosslinking treatment.

Specific examples of an organic such peroxide include butyl peroxyneododecanoate, octanoyl peroxide, dilauroyl peroxide, succinic peroxide, a mixture of toluoyl peroxide and benzoyl peroxide, benzoyl peroxide, bis(butylperoxy)trimethylcyclohexane, butyl peroxylaurate, dimethyldi (benzoylperoxy) hexane, bis(butylperoxy)methylcyclohexane, bis(butylperoxy)cyclohexane, butyl peroxybenzoate, butylbis(butylperoxy) valerate, dicumyl peroxide, di-t-hexyl peroxide, t-butylperoxy-2-ethylhexanoate, t-butyl peroxyisobutyrate, t-butyl peroxypivalate, t-hexyl peroxypivalate, t-butylperoxymethyl monocarbonate, t-pentylperoxymethyl monocarbonate, t-hexylperoxymethyl monocarbonate, t-heptylperoxymethyl monocarbonate, t-octylperoxymethyl monocarbonate, 1,1,3,3-tetramethylbutylperoxymethyl monocarbonate, t-butylperoxyethyl monocarbonate, t-pentylperoxyethyl monocarbonate, t-hexylperoxyethyl monocarbonate, t-heptylperoxyethyl monocarbonate, t-octylperoxyethyl monocarbonate, 1,1,3,3-tetramethylbutylperoxyethyl monocarbonate, t-butylperoxy n-propyl monocarbonate, t-pentylperoxy n-propyl monocarbonate, t-hexylperoxy n-propyl monocarbonate, t-heptylperoxy n-propyl monocarbonate, t-octylperoxy n-propyl monocarbonate, 1,1,3,3-tetramethylbutylperoxy n-propyl monocarbonate, t-butylperoxyisopropyl monocarbonate, t-pentylperoxyisopropyl monocarbonate, t-hexylperoxyisopropyl monocarbonate, t-heptylperoxyisopropyl monocarbonate, t-octylperoxyisopropyl monocarbonate, 1,1,3,3-tetramethylbutyl peroxyisopropyl monocarbonate, t-butylperoxy n-butyl monocarbonate, t-pentylperoxy n-butyl monocarbonate, t-hexylperoxy n-butyl monocarbonate, t-heptylperoxy n-butyl monocarbonate, t-octylperoxy n-butyl monocarbonate, 1,1,3,3-tetramethylbutylperoxy n-butyl monocarbonate, t-butylperoxyisobutyl monocarbonate, t-pentylperoxyisobutyl monocarbonate, t-hexylperoxyisobutyl monocarbonate, t-heptylperoxyisobutyl monocarbonate, t-octylperoxyisobutyl monocarbonate, 1,1,3,3-tetramethylbutylperoxyisobutyl monocarbonate, t-butylperoxy sec-butyl monocarbonate, t-pentylperoxy sec-butyl monocarbonate, t-hexylperoxy sec-butyl monocarbonate, t-heptylperoxy sec-butyl monocarbonate, t-octylperoxy sec-butyl monocarbonate, 1,1,3,3-tetramethylbutylperoxy sec-butyl monocarbonate, t-butylperoxy t-butyl monocarbonate, t-pentylperoxy t-butyl monocarbonate, t-hexylperoxy t-butyl monocarbonate, t-heptylperoxy t-butyl monocarbonate, t-octylperoxy t-butyl monocarbonate, 1,1,3,3-tetramethylbutylperoxy t-butyl monocarbonate, t-butylperoxy 2-ethylhexyl monocarbonate, t-pentylperoxy 2-ethylhexyl monocarbonate, t-hexylperoxy 2-ethylhexyl monocarbonate, t-heptylperoxy 2-ethylhexyl monocarbonate, t-octylperoxy 2-ethylhexyl monocarbonate, 1,1,3,3-tetramethylbutylperoxy 2-ethylhexyl monocarbonate, diisobutyl peroxide, cumylperoxy neodecanoate, di-n-propylperoxy dicarbonate, diisopropylperoxy dicarbonate, di-sec-butylperoxy dicarbonate, 1,1,3,3-tetramethylbutylperoxy neodecanoate, bis(4-t-butylcyclohexyl) peroxy dicarbonate, bis(2-ethylhexyl) peroxy dicarbonate, t-hexylperoxy neodecanoate, t-butylperoxy neodecanoate, t-butylperoxy neoheptanoate, t-hexyl peroxypivalate, t-butyl peroxypivalate, di(3,5,5-trimethylhexanoyl) peroxide, dilauroyl peroxide, 1,1,3,3-tetramethylbutylperoxy-2-ethylhexanoate, disuccinate peroxide, 2,5-dimethyl-2,5-bis(2-ethylhexanoylperoxy) hexane, t-hexylperoxy-2-ethylhexanoate, di(4-methylbenzoyl) peroxide, dibenzoyl peroxide, t-butylperoxy 2-ethylhexyl carbonate, t-butylperoxy isopropyl carbonate, 1,6-bis(t-butylperoxycarbonyloxy) hexane, t-butylperoxy-3,5,5-trimethyl hexanoate, t-butylperoxy acetate, t-butylperoxy benzoate, t-amylperoxy-3,5,5-trimethylhexanoate, 2,2-bis(4,4-di-t-butylperoxycyclohexy) propane, 2,2-di-t-butylperoxybutane, and the like. As the organic peroxide, one type may be used alone, or two or more types may be used in combination.

Among these, t-butylperoxyisopropyl monocarbonate, t-pentylperoxyisopropyl monocarbonate, t-hexylperoxyisopropyl monocarbonate, t-butylperoxy 2-ethylhexyl monocarbonate, t-pentylperoxy 2-ethylhexyl monocarbonate, t-hexylperoxy 2-ethylhexyl monocarbonate, t-amylperoxyisopropyl monocarbonate, di-t-hexyl peroxide, t-butylperoxy-2-ethylhexanoate, t-butyl peroxyisobutyrate, t-hexylperoxy-2-ethylhexanoate, 1,1,3,3-tetramethylbutylperoxy-2-ethylhexanoate, t-butyl peroxypivalate, t-hexyl peroxypivalate, t-butylperoxy neodecanoate, t-hexylperoxy neodecanoate, and 1,1,3,3-tetramethylbutylperoxy neodecanoate are preferable organic peroxides because those organic peroxides can efficiently promote crosslinking of the resin constituting the resin particles.

The peroxide is preferably a compound exhibiting a 1-hour half-life temperature of 200° C. or lower, more preferably a compound exhibiting 170° C. or lower, further preferably a compound exhibiting 140° C. or lower, because the heating temperature during crosslinking treatment can be set low. The lower limit of the 1-hour half-life temperature of the peroxide may be 50° C. or higher, may be 60° C. or higher, or may be 70° C. or higher.

As the organic peroxide exhibiting such a 1-hour half-life temperature, t-butylperoxyisopropyl monocarbonate, t-butylperoxy 2-ethylhexyl monocarbonate, di-sec-butylperoxy dicarbonate, t-butylperoxy 2-ethylhexanoate, t-butyl peroxyisobutyrate, t-hexylperoxy 2-ethylhexanoate, 1,1,3,3-tetramethylbutylperoxy-2-ethylhexanoate, t-butyl peroxypivalate, t-butylperoxy neodecanoate, t-hexylperoxy neodecanoate, and 1,1,3,3-tetramethylbutylperoxy neodecanoate are particularly preferable.

The following description will discuss a case where the peroxide is an inorganic peroxide. Examples of the inorganic peroxide include hydrogen peroxide, potassium peroxide, calcium peroxide, sodium peroxide, magnesium peroxide, potassium persulfate, sodium persulfate, ammonium persulfate, and the like, in consideration of the heating temperature and/or time during crosslinking treatment. Among these, hydrogen peroxide, potassium persulfate, sodium persulfate, and ammonium persulfate are preferable in terms of ease of handling and having a decomposition temperature suitable for the heating temperature during crosslinking treatment. As the inorganic peroxide, one type may be used alone, or two or more types may be used in combination. Alternatively, an organic peroxide and an inorganic peroxide may be used in combination. (Polyfunctional compound)

The crosslinked structure in the present crosslinked resin particles (B) may be introduced using only a peroxide. Note, however, that the crosslinked structure is preferably introduced using both a peroxide and a polyfunctional compound. That is, the present crosslinked resin particles (B) are preferably crosslinked in the presence of a peroxide and a polyfunctional compound. In a case where both a peroxide and a polyfunctional compound are used, the gel fraction of the crosslinked resin particles (B) can be increased with a smaller amount of the peroxide, as compared with a case of using only a peroxide.

The polyfunctional compound refers to a compound having, in one molecule, two or more functional groups (for example, radical reactive groups) capable of crosslinking a resin (for example, PHA) constituting the resin particles. The polyfunctional compound is not particularly limited, and is preferably a compound having reactivity with radicals generated from a peroxide, and particularly preferably a compound having two or more radical reactive groups in one molecule. As the radical reactive group, at least one selected from the group consisting of a vinyl group, an allyl group, an acryloyl group, and a methacryloyl group is preferable.

Examples of such a polyfunctional compound include, but are not particularly limited to, allyl (meth)acrylate; allyl alkyl (meth)acrylates; allyl oxyalkyl (meth)acrylates; polyfunctional (meth)acrylates having two or more (meth)acrylic groups such as ethylene glycol di(meth)acrylate, butanediol di(meth)acrylate, triethylene glycol di(meth)acrylate, tetraethylene glycol di(meth)acrylate, polyethylene glycol di(meth)acrylate, trimethylolpropane tri(meth)acrylate, and pentaerythritol (meth)acrylate; divinylbenzene, diallyl phthalate, triallyl cyanurate, triallyl isocyanurate, divinylbenzene, and the like. The polyfunctional compound is preferably one or more selected from the group consisting of allyl methacrylate, triallyl isocyanurate, butanediol di(meth)acrylate, and divinylbenzene, particularly preferably one or more selected from the group consisting of allyl methacrylate and triallyl isocyanurate.

In a case where a crosslinked structure is formed in the presence of a polyfunctional compound, the obtained crosslinked resin particles (B) can usually contain a structure derived from the polyfunctional compound. In this case, molecular chains of the resin constituting the resin particles are bonded to each other via the structure derived from the polyfunctional compound.

### (Other Components)

The present crosslinked resin particles (B) are crosslinked resin particles containing PHA. Therefore, the present crosslinked resin particles (B) may be crosslinked resin particles containing only PHA, or may be crosslinked resin particles containing other components in addition to PHA. Examples of the other components include resins other than PHA, antioxidants, hydrolysis inhibitors, anti-blocking agents, crystal nucleating agents, lubricants, ultraviolet absorbents, and the like.

The proportion of PHA in the present crosslinked resin particles (B) is not particularly limited. The contained amount of the PHA in 100% by weight of a resin component of the present crosslinked resin particles (B) may be not less than 50% by weight, preferably not less than 70% by weight, more preferably not less than 80% by weight, further preferably not less than 90% by weight, particularly preferably not less than 95% by weight, and may be not less than 99% by weight. The upper limit of the contained amount of the PHA in 100% by weight of the resin component of the present crosslinked resin particles (B) is not particularly limited, and only needs to be not more than 100% by weight. The “resin component of the crosslinked resin particles” intends a resin substantially constituting the crosslinked resin particles, and does not include a component (for example, a structure derived from a polyfunctional compound) crosslinking molecular chains of the resin and a residue (for example, an unreacted peroxide, a decomposition product of a peroxide, an unreacted polyfunctional compound, and the like) of a component used for crosslinking molecular chains of the resin.

Examples of the resin other than PHA include aliphatic polyesters other than PHA, aliphatic aromatic polyesters, and the like. Examples of the aliphatic polyester other than PHA include (i) polycaprolactone (PCL), (ii) polylactic acid (PLA), and (iii) an aliphatic polyester having a structure in which aliphatic diol and aliphatic dicarboxylic acid are polycondensed. Specific examples of the aliphatic polyester having a structure in which aliphatic diol and aliphatic dicarboxylic acid are polycondensed include polyethylene succinate, polybutylene succinate (hereinafter sometimes referred to as “PBS”), polyhexamethylene succinate, polyethylene adipate, polybutylene adipate, polyhexamethylene adipate, polybutylene succinate adipate (hereinafter sometimes referred to as “PBSA”), polyethylene sebacate, polybutylene sebacate, and the like. Examples of the aliphatic aromatic polyester include aliphatic aromatic polyesters (using both an aliphatic compound and an aromatic compound as monomers) obtained by using both an aliphatic compound and an aromatic compound as monomers and copolymerizing these monomers. Examples of the aliphatic aromatic polyester include polybutylene adipate terephthalate (hereinafter sometimes referred to as “PBAT”), polybutylene sebacate terephthalate (hereinafter sometimes referred to as “PBSeT”), polybutylene azelate terephthalate (hereinafter sometimes referred to as “PBAZT”), polybutylene succinate terephthalate (hereinafter sometimes referred to as “PBST”), polybutylene succinate adipate terephthalate (hereinafter sometimes referred to as “PBSAT”), and the like. These resins other than PHA may be used alone or in combination of two or more. In the present crosslinked resin particles (B), the resin other than PHA may be crosslinked or may not be crosslinked.

The present crosslinked resin particles (B) are different from expanded resin particles as disclosed in International Publication No. WO 2007/049694 and International Publication No. WO 2019/146555, and are preferably non-expanded particles. In other words, the present crosslinked resin particles (B) preferably contain substantially air no bubbles inside the particles. “Substantially containing no air bubbles inside the particle” intends that the volume of air bubbles (space) is 10% or less in 100% of the volume of the crosslinked resin particles (B).

In a case where the present crosslinked resin particles (B) are not expanded, the apparent density of the crosslinked resin particles (B) exhibits a relatively large value. The apparent density of the present crosslinked resin particles (B) is preferably more than 0.6 g/cm³, more preferably 0.7 g/cm³ or more, further preferably 0.9 g/cm³ or more. The apparent density of the present crosslinked resin particles (B) can be determined by a method described in JIS K0061 (Method for measuring density and specific gravity of chemical products) or JIS Z8807 (Method for measuring density and specific gravity of solid).

The average weight per particle of the present crosslinked resin particles (B) is not particularly limited. For example, in a case where the volume-average particle size of the present crosslinked resin particles (B) is 10.00 μm or less, the average weight per particle of the crosslinked resin particles (B) can be a value far below 0.1 mg.

The present crosslinked resin particles (B) may be dried. The shape after drying can be a shape such as powder, pellets, crumbs, a film, or a sheet, depending on the drying method.

### (Method for Producing Crosslinked Resin Particles (B))

The following description will specifically discuss an example of a method for producing the present crosslinked resin particles (B). The present crosslinked resin particles (B) can be produced by crosslinking molecular chains of a resin in the presence of a peroxide in an aqueous dispersion containing resin particles before crosslinking treatment.

The “resin particles” intend particles composed of a resin component substantially constituting crosslinked resin particles. In a case where the resin component is composed only of PHA, the resin particles can also be said to be PHA particles. In order to efficiently crosslink molecular chains of the resin, it is preferable to heat an aqueous dispersion of resin particles containing a peroxide to a temperature suitable for decomposition of the peroxide.

More specifically, the method for producing the present crosslinked resin particles (B) preferably includes a step (1) of preparing an aqueous dispersion of resin particles in which resin particles (for example, PHA particles) before crosslinking treatment are dispersed in water, a step (2) of adding a peroxide to the aqueous dispersion of the resin particles to impregnate the resin particles with the peroxide, and a step (3) of heating the aqueous dispersion of the resin particles impregnated with the peroxide to a heating temperature to crosslink molecular chains of the resin (for example, molecular chains of PHA). Furthermore, it is more preferable to include a step (4) of maintaining the heating temperature after entirely adding the peroxide.

In the step (1), for example, the aqueous dispersion of PHA particles may be an aqueous dispersion obtained by culturing PHA-producing microorganisms to accumulate PHA in bacterial cells, and then disrupting the bacterial cells in the culture solution to separate and remove bacterial cell components, or an aqueous dispersion obtained by concentrating or diluting the aqueous dispersion. According to such a method, the process from the preparation of PHA particles by culturing the PHA-producing microorganisms to the crosslinking treatment can be carried out without separating the PHA particles from water.

The aqueous dispersion of resin particles (for example, PHA particles) can also be prepared by dispersing dried resin particles (for example, PHA particles) in water.

The aqueous medium contained in the aqueous dispersion may be only water, or may be a mixed solvent of water and an organic solvent compatible with water. In the mixed solvent, the concentration of the organic solvent compatible with water is not particularly limited, as long as the concentration is equal to or less than the solubility of the organic solvent used in water.

The organic solvent is not particularly limited, and examples thereof include alcohols such as methanol, ethanol, 1-propanol, 2-propanol, 1-butanol, 2-butanol, isobutanol, pentanol, hexanol, and heptanol; ketones such as acetone and methyl ethyl ketone; ethers such as tetrahydrofuran and dioxane; nitriles such as acetonitrile and propionitrile; amides such as dimethylformamide and acetamide; dimethyl sulfoxide; pyridine; piperidine; and the like. Among these, methanol, ethanol, 1-propanol, 2-propanol, 1-butanol, 2-butanol, isobutanol, acetone, methyl ethyl ketone, tetrahydrofuran, dioxane, acetonitrile, propionitrile, and the like are preferable from the viewpoint of being easy to remove. Further, methanol, ethanol, 1-propanol, 2-propanol, butanol, acetone, and the like are more preferable from the viewpoint of being easily available. Furthermore, methanol, ethanol, and acetone are particularly preferable.

The contained amount of water in the entire aqueous medium (100% by weight) constituting the aqueous dispersion is preferably 5% by weight to 100% by weight. The contained amount of water in 100% by weight of the aqueous medium is more preferably not less than 10% by weight, more preferably not less than 30% by weight, further preferably not less than 50% by weight, particularly preferably not less than 70% by weight. The contained amount of water in 100% by weight of the aqueous medium may be not less than 90% by weight, or may be not less than 95% by weight.

In the aqueous dispersion, the volume-average particle size of the resin particles is preferably within the same range as the volume-average particle size of the crosslinked resin particles (B) described above. In a case of PHA particles produced by PHA-producing microorganisms, the volume-average particle size can typically be within the above range. Therefore, an aqueous dispersion of PHA particles having a desired volume-average particle size can be obtained without carrying out a special step for adjusting the particle size.

The concentration of the resin particles in the aqueous dispersion is not particularly limited and can be appropriately set, and may be, for example, approximately 1 to 70% by weight, preferably approximately 5 to 50% by weight.

The aqueous dispersion of resin particles preferably contains a dispersion agent in order to enhance the dispersibility of the resin particles and allow the crosslinking reaction to proceed uniformly. Examples of the dispersion agent include anionic surfactants such as sodium dioctyl sulfosuccinate, sodium dodecyl sulfate, sodium lauryl sulfate, and sodium oleate; cationic surfactants such as lauryl trimethyl ammonium chloride; nonionic surfactants such as glycerin fatty acid ester, sorbitan fatty acid ester, sucrose fatty acid ester, polyoxyethylene alkyl ether, polyoxyethylene alkyl phenyl ether, and polyoxyethylene polyoxypropylene glycol; water-soluble polymers such as polyvinyl alcohol, ethylene-modified polyvinyl alcohol, polyvinylpyrrolidone, methyl cellulose, ethyl cellulose, hydroxymethyl cellulose, hydroxyethyl cellulose, polyacrylic acid, sodium polyacrylate, potassium polyacrylate, polymethacrylic acid, and sodium polymethacrylate; and the like. One type of these dispersion agents may be used alone, or two or more types thereof may be used in combination.

In a case where a dispersion agent is used, the contained amount (addition amount) of the dispersion agent in the aqueous dispersion is not particularly limited. The contained amount of the dispersion agent in the aqueous dispersion may be, for example, 0.1 parts by weight to 10 parts by weight, preferably 0.5 parts by weight to 5 parts by weight, particularly preferably 0.5 parts by weight to 3 parts by weight, with respect to 100 parts by weight of the resin particles.

In the step (2), a peroxide is added to the aqueous dispersion of the resin particles obtained in the step (1) to impregnate the resin particles with the peroxide. As the peroxide, those described above can be used. The peroxide can be added in various forms such as solid and liquid. Further, a liquid form diluted with a diluent or the like may be added. The peroxide may be added all at once, or may be added continuously or in portions.

In a case where the peroxide and the polyfunctional compound are used in combination, it is preferable to also add a polyfunctional compound to the aqueous dispersion of the resin particles in this step (2). As the polyfunctional compound, those described above can be used. The polyfunctional compound can be added in various forms such as solid and liquid. Further, a liquid form diluted with a diluent or the like may be added. The polyfunctional compound may be added all at once, or may be added continuously or in portions.

In the step (2), examples of a method for impregnating the resin particles with the peroxide and the optional polyfunctional compound include a method in which, after or while adding these compounds to the aqueous dispersion of the resin particles, the temperature of the aqueous dispersion is set to, for example, 0° C. or higher and lower than a temperature suitable for decomposition of the peroxide employed in the next step (3), and the temperature is maintained for, for example, approximately 1 minute to 5 hours while stirring the aqueous dispersion. Specifically, the temperature of the aqueous dispersion during impregnation may be approximately 0° C. to 80° C.

The amount of the peroxide used can be appropriately set in consideration of the gel fraction of the crosslinked resin particles (B). The amount of the peroxide used is, for example, preferably 0.01 parts by weight to 10 parts by weight, more preferably 0.1 parts by weight to 8 parts by weight, further preferably 0.3 parts by weight to 5 parts by weight, particularly preferably 0.5 parts by weight to 3 parts by weight, with respect to 100 parts by weight of the resin particles.

According to the production method in which resin particles are crosslinked in an aqueous dispersion using a peroxide, it is easy to proceed with crosslinking while maintaining the particle size (volume) before crosslinking to obtain crosslinked resin particles (B). Meanwhile, in a method of crosslinking a resin by melt-kneading in the presence of a peroxide, it may be difficult to achieve this.

Further, according to the production method in which resin particles are crosslinked in an aqueous dispersion using a peroxide, there is an advantage that temperature rise due to heat generated during the crosslinking reaction can be easily controlled, and crosslinked resin particles (B) having a stable crosslinked structure (quality) can be safely and efficiently obtained.

The amount of the polyfunctional compound used may also be appropriately set in consideration of the gel fraction of the crosslinked resin particles (B). The amount of the polyfunctional compound used is, for example, preferably 0.01 parts by weight to 20 parts by weight, more preferably 0.05 parts by weight to 15 parts by weight, further preferably 0.1 parts by weight to 10 parts by weight, furthermore preferably 0.2 parts by weight to 5 parts by weight, particularly preferably 0.3 parts by weight to 3 parts by weight, with respect to 100 parts by weight of the resin particles.

In the step (3), the aqueous dispersion of the resin particles impregnated with the peroxide is heated to a temperature suitable for decomposition of the peroxide. The heating temperature is preferably within a range of approximately 25° C. above and below the 1-hour half-life temperature of the peroxide described above (i.e., 1-hour half-life temperature minus 25° C. to 1-hour half-life temperature plus 25° C.). Specifically, the heating temperature is preferably 30° C. to 140° C., more preferably 50° C. to 135° C., further preferably 60° C. to 130° C. According to this method, the resin (for example, PHA) can be crosslinked at a temperature lower than the melting temperature of the resin. Therefore, deterioration of the resin due to heating during the crosslinking treatment can be avoided. The melting temperature of PHA is, for example, 50° C. to 210° C.

In the subsequent step (4), it is preferable to maintain the heating temperature. Thereby, the crosslinking reaction using the peroxide can be sufficiently advanced. The time for maintaining the heating temperature is not particularly limited, and is preferably 1 minute to 15 hours, more preferably 1 hour to 10 hours.

After completion of the crosslinking reaction, dried crosslinked resin particles (B) can be obtained by separating the crosslinked resin particles (B) from the aqueous dispersion and removing water from the separated crosslinked resin particles (B). The method for separating the crosslinked resin particles (B) from the aqueous dispersion is not particularly limited, and for example, filtration, centrifugal separation, heat drying, freeze drying, spray drying, or the like can be used. For example, in a case where spray drying is used, dried crosslinked resin particles (B) can be obtained directly from the aqueous dispersion. Alternatively, the crosslinked resin particles (B) can be obtained in a pellet form while completely removing residual moisture by extruding the crosslinked resin particles (B) alone after separation from the aqueous dispersion. Further, an agglutination step by using a coagulant and/or pH adjustment may be carried out.

The contained amount of the crosslinked resin particles (B) in the present resin composition is 1.0 part by weight to 15.0 parts by weight in a total of 100 parts by weight of the thermoplastic resin (A), the crosslinked resin particles (B), and the inorganic filler (C). According to this configuration, the thermoplastic resin composition can provide a molded product excellent in impact strength. The contained amount of the crosslinked resin particles (B) in the present resin composition may be not less than 5.0 parts by weight, may be not less than 7.0 parts by weight, or may be not less than 10.0 parts by weight in a total of 100 parts by weight of the thermoplastic resin (A), the crosslinked resin particles (B), and the inorganic filler (C). The contained amount of the crosslinked resin particles (B) in the present resin composition is preferably not more than 14.0 parts by weight, more preferably not more than 13.0 parts by weight, particularly preferably not more than 12.0 parts by weight in a total of 100 parts by weight of the thermoplastic resin (A), the crosslinked resin particles (B), and the inorganic filler (C).

### <Thermoplastic Resin (A)>

In the present resin composition, the thermoplastic resin (A) can also be said to be a matrix resin. The thermoplastic resin (A) is not particularly limited, as long as the thermoplastic resin (A) is a resin that can be melted by heating and then cooled and solidified to be molded into a desired shape. Specific examples of the thermoplastic resin (A) include polyolefin-based resins such as polyethylene and polypropylene, polyvinyl chloride, polystyrene, polyvinyl acetate, polyurethane, polytetrafluoroethylene, acrylic resins such as polymethyl methacrylic acid, AS resins, polyamides, polyacetals, polycarbonates, modified polyphenylene ethers, polyester-based resins, cyclic polyolefins, and the like. One type of these thermoplastic resins (A) may be used alone, or two or more types thereof may be used in combination. The thermoplastic resin (A) preferably has a gel fraction of less than 50%. The thermoplastic resin (A) is preferably not crosslinked.

As the thermoplastic resin (A), a polyester-based resin is particularly preferable. Examples of the polyester-based resin include aliphatic polyesters (for example, PHA, PLA, PCL, aliphatic polyesters having a structure in which an aliphatic diol and an aliphatic dicarboxylic acid are polycondensed, and the like), aliphatic aromatic polyesters, and the like.

Specific aspects of the aliphatic polyester and the aliphatic aromatic polyester are the same as those described in the sections of (PHA) and (Other components) in the section of <Crosslinked resin particles (B)>above, and therefore those descriptions are applied and not repeated here.

The crosslinked resin particles (B) contain PHA having biodegradability. Therefore, the thermoplastic resin (A) also preferably contains a resin having biodegradability, that is, a biodegradable resin. According to this configuration, there is an advantage that the biodegradability of the entire thermoplastic resin composition and the entire molded product of the thermoplastic resin composition can be enhanced. Therefore, in a case where the thermoplastic resin (A) contains a biodegradable resin, it is expected to be useful as a thermoplastic resin composition that addresses the problem of plastic waste and is friendly to the global environment. Further, in a case where the thermoplastic resin (A) contains a biodegradable resin, the present resin composition and a molded product thereof can inhibit soil pollution due to disposal. This makes it possible to contribute to achieving, for example, Sustainable Development Goals (SDGs) such as Goal 12 “Ensure sustainable consumption and production patterns”. Furthermore, in a case where the biodegradable resin contained in the thermoplastic resin (A) has marine degradability in addition to soil degradability, the resin composition and molded product containing the present crosslinked resin particles (B) can inhibit marine pollution in addition to inhibition of soil pollution due to disposal.

Further, in a case where the crosslinked resin particles (B) contain a resin produced from a plant-derived raw material, from the viewpoint of resource circulation, the thermoplastic resin (A) preferably also contains a resin produced from a plant-derived raw material, and more preferably is composed only of a resin produced from a plant-derived raw material.

The following description will discuss a case where the thermoplastic resin (A) contains a biodegradable resin. The thermoplastic resin (A) preferably contains 10% by weight to 100% by weight of a biodegradable resin in 100% by weight of the thermoplastic resin (A). The amount of the biodegradable resin contained in the thermoplastic resin (A) is more preferably not less than 30% by weight, further preferably not less than 50% by weight, furthermore preferably not less than 70% by weight, particularly preferably not less than 90% by weight, in 100% by weight of the thermoplastic resin (A). The thermoplastic resin (A) may be composed only of a biodegradable resin.

The biodegradable resin contained in the thermoplastic resin (A) preferably contains a polyester-based resin, more preferably contains an aliphatic polyester, particularly preferably contains PHA and/or polylactic acid, because the thermoplastic resin composition and the molded product thereof can enjoy a large effect of improving impact strength by the crosslinked resin particles (B). The PHA used as the thermoplastic resin (A) preferably has a gel fraction of less than 50%. Further, the PHA used as the thermoplastic resin (A) preferably has no crosslinked structure.

The following description will discuss a case where the thermoplastic resin (A) contains PHA and/or polylactic acid as a biodegradable resin. The total amount of PHA and polylactic acid contained in the thermoplastic resin (A) is preferably 10% by weight to 100% by weight, more preferably not less than 30% by weight, further preferably not less than 50% by weight, furthermore preferably not less than 70% by weight, particularly preferably not less than 90% by weight, in 100% by weight of the thermoplastic resin (A).

The PHA usable as the thermoplastic resin (A) is not particularly limited, and examples thereof include polyglycolic acid, P3HA, a poly(4-hydroxyalkanoate)-based resin, and the like. As the PHA, only one type may be used, or two or more types may be used in combination. As the PHA used as the thermoplastic resin (A), P3HA is particularly preferable.

The following description will discuss a case where the crosslinked resin particles (B) contain P3HA and the thermoplastic resin (A) contains P3HA. The P3HA usable as the thermoplastic resin (A) is the same as the P3HA related to the crosslinked resin particles (B), and various P3HAs described above can be used. The P3HA contained in the thermoplastic resin (A) may be a resin having the same composition as the P3HA contained in the crosslinked resin particles (B), or may be a resin having a different composition and/or physical properties. The P3HA contained in the thermoplastic resin (A) is preferably a resin having a composition and/or physical properties different from those of the P3HA contained in the crosslinked resin particles (B), and is more preferably a resin harder than the P3HA contained in the crosslinked resin particles (B).

The following description will discuss a case where the P3HA used as the thermoplastic resin (A) contains a 3-hydroxybutanoic acid (3HB) repeating unit. In this case, from the viewpoint of a balance between flexibility and strength, the compositional ratio of the 3HB repeating unit in all monomer repeating units (100 mol %) of the P3HA is preferably 80 mol % to 99 mol %, more preferably 82 mol % to 97 mol %. In a case where the compositional ratio of the 3HB repeating unit in the P3HA is 80 mol % or more, rigidity of the P3HA can be further improved. Meanwhile, in a case where the compositional ratio of the 3HB repeating unit in the P3HA is 99 mol % or less, flexibility of the P3HA tends to be further improved. As the P3HA, two or more types having different compositional ratios of the 3HB repeating unit may be used in combination.

The weight-average molecular weight of the PHA used as the thermoplastic resin (A) is not particularly limited, and is preferably 50,000 to 3,000,000, more preferably 100,000 to 2,000, 000, further preferably 150,000 to 1,500,000. In a case where the weight-average molecular weight of the PHA is 50,000 or more, sufficient impact strength can be obtained in the present resin composition and a molded product thereof. Meanwhile, PHA having a weight-average molecular weight of 3,000,000 or less may have an advantage that production of PHA is easy and/or an advantage that such PHA is easy to handle in order to attain the object of an embodiment of the present invention.

As the polylactic acid usable as the thermoplastic resin (A), conventionally known polylactic acid can be used. The polylactic acid may be crystalline polylactic acid, amorphous polylactic acid, or a mixture of crystalline polylactic acid and amorphous polylactic acid.

The polylactic acid may be a homopolymer of lactic acid or a copolymer of lactic acid and another monomer. Alternatively, the polylactic acid may be a blended product of a homopolymer of lactic acid and a copolymer of lactic acid and another monomer.

Examples of the other monomer include aliphatic hydroxycarboxylic acids other than lactic acid, aliphatic polyhydric alcohols, aliphatic polyvalent carboxylic acids, polyfunctional polysaccharides, and the like.

Lactic acid raw materials for producing polylactic acid are not particularly limited, and L-lactic acid, D-lactic acid, DL-lactic acid, or a mixture thereof, or L-lactide, D-lactide, meso-lactide, or a mixture thereof, or the like can be used. Lactic acid obtained by microbial fermentation from plant-derived renewable raw materials such as starch can be suitably used.

A method for producing polylactic acid is not particularly limited, and known methods such as a dehydration polycondensation method and a ring-opening polymerization method can be applied.

The weight-average molecular weight of the polylactic acid used as the thermoplastic resin (A) is not particularly limited, and is preferably 50,000 to 1,000,000, more preferably 70,000 to 700,000, further preferably 100,000 to 400,000. In a case where the weight-average molecular weight of the polylactic acid is 50,000 or more, sufficient impact strength can be obtained in the present resin composition and a molded product thereof. Meanwhile, polylactic acid having a weight-average molecular weight of 1,000,000 or less may have an advantage that production of polylactic acid is easy and/or an advantage that such polylactic acid is easy to handle in order to attain the object of an embodiment of the present invention.

In regard to the PHA used as the thermoplastic resin (A), aspects other than those described above are the same as those described in the section of (PHA) above, and therefore those descriptions are applied and not repeated here.

The contained amount of the thermoplastic resin (A) in the present resin composition is 40.0 parts by weight to 98.0 parts by weight in a total of 100 parts by weight of the thermoplastic resin (A), the crosslinked resin particles (B), and the inorganic filler (C). According to this configuration, the thermoplastic resin composition can provide a molded product excellent in impact strength. The contained amount of the thermoplastic resin (A) in the present resin composition may be 40.0 parts by weight to 95.0 parts by weight, may be 45.0 parts by weight to 93.0 parts by weight, may be 47.0 parts by weight to 90.0 parts by weight, may be 50.0 parts by weight to 85.0 parts by weight, may be 50.0 parts by weight to 80.0 parts by weight, may be 50.0 parts by weight to 75.0 parts by weight, or may be 50.0 parts by weight to 70.0 parts by weight, in a total of 100 parts by weight of the thermoplastic resin (A), the crosslinked resin particles (B), and the inorganic filler (C). The contained amount of the thermoplastic resin (A) in the present resin composition may be not less than 55.00 parts by weight, may be not less than 60.00 parts by weight, may be not less than 70.00 parts by weight, may be not less than 80.00 parts by weight, may be not less than 85.00 parts by weight, may be not less than 88.00 parts by weight, or may be not less than 90.00 parts by weight, in a total of 100 parts by weight of the thermoplastic resin (A) and the crosslinked resin particles (B).

### <Inorganic Filler (C)>

The present resin composition contains an inorganic filler (C). In a case where the present resin composition contains the inorganic filler (C), there is an advantage that rigidity can be further increased.

Examples of the inorganic filler (C) include, but are not limited to, silica-based inorganic fillers (for example, quartz, fumed silica, silicic anhydride, fused silica, crystalline silica, amorphous silica, fillers obtained by condensing alkoxysilane, ultrafine amorphous silica powder, and the like), alumina, zircon, iron oxide, zinc oxide, titanium oxide, silicon nitride, boron nitride, aluminum nitride, silicon carbide, glass, silicone rubber, silicone resin, carbon fiber, mica, graphite, carbon black, ferrite, graphite, diatomaceous earth, white clay, clay, talc, kaolinite, calcium carbonate, manganese carbonate, magnesium carbonate, barium sulfate, silver powder, and the like. One type of these inorganic fillers (C) may be used alone or two or more types thereof may be used in combination.

From the viewpoint of rigidity improvement effect and dispersibility when kneaded with a thermoplastic resin, the inorganic filler (C) is preferably at least one selected from the group consisting of mica, talc, kaolinite, and calcium carbonate.

The contained amount of the inorganic filler (C) in the present resin composition is 1.0 part by weight to 50.0 parts by weight, in a total of 100 parts by weight of the thermoplastic resin (A), the crosslinked resin particles (B), and the inorganic filler (C). According to this configuration, the thermoplastic resin composition can provide a molded product excellent in impact strength. The contained amount of the inorganic filler (C) in the present resin composition may be 5.0 parts by weight to 45.0 parts by weight, may be 10.0 parts by weight to 40.0 parts by weight, may be 15.0 parts by weight to 40.0 parts by weight, or may be 20.0 parts by weight to 35.0 parts by weight, in a total of 100 parts by weight of the thermoplastic resin (A), the crosslinked resin particles (B), and the inorganic filler (C).

The compounds described above as the inorganic filler (C) include compounds capable of exhibiting effects (for example, effects as a crystal nucleating agent, coloring agents such as titanium oxide and carbon black, and the like) other than that of an inorganic filler. In the present specification, each of the compounds described above is regarded as an inorganic filler even if the compound exhibits an effect other than that of an inorganic filler, and the contained amount thereof is regarded as the contained amount of the inorganic filler (C).

The volume-average particle size of the inorganic filler (C) is preferably 0.1 μm to 100 μm, more preferably 0.1 μm to 50 μm, further preferably 0.1 μm to 30 μm, particularly preferably 0.1 μm to 15 μm, because the thermoplastic resin composition has excellent characteristics and/or processability. The volume-average particle size can be measured using a laser diffraction/scattering type device such as “Microtrac MT3100II” manufactured by Nikkiso Co., Ltd. or “LA-9050V2” manufactured by Horiba, Ltd.

The inorganic filler may be surface-treated in order to increase dispersibility in the thermoplastic resin composition. Examples of a treatment agent used for the surface treatment include higher fatty acids, silane coupling agents, titanate coupling agents, sol-gel coating agents, resin coating agents, and the like.

The water content of the inorganic filler is preferably 0.01% to 10.00%, more preferably 0.01% to 5.00%, further preferably 0.01% to 1.00%, because hydrolysis of the poly(hydroxyalkanoate)-based resin is easily inhibited. The water content can be determined in conformance with JIS-K5101.

### <Lubricant>

The present resin composition may further contain a lubricant. In a case where the thermoplastic resin composition contains a lubricant, the surface smoothness of the obtained molded product can be improved.

The lubricant is not particularly limited. Examples of the lubricant include, but are not limited to, fatty acid metal salts such as magnesium stearate and calcium stearate; fatty acid amides such as behenic acid amide, stearic acid amide, erucic acid amide, oleic acid amide, methylenebisstearic acid amide, and ethylenebisstearic acid amide; polyethylene wax; oxidized polyester wax; glycerol monofatty acid esters such as glycerol monostearate, glycerol monobehenate, and glycerol monolaurate; organic acid monoglycerides such as succinic acid saturated fatty acid monoglyceride; sorbitan fatty acid esters such as sorbitan behenate, sorbitan stearate, and sorbitan laurate; polyglycerol fatty acid esters such as diglycerol stearate, diglycerol laurate, tetraglycerol stearate, tetraglycerol laurate, decaglycerol stearate, and decaglycerol laurate; higher alcohol fatty acid esters such as stearyl stearate; and the like. As the lubricant, one type may be used alone, or two or more types may be used in combination.

The contained amount of the lubricant (in a case where a plurality of lubricants are used, a total amount thereof) is not particularly limited, as long as lubricity can be imparted to the molded product. The contained amount of the lubricant is preferably 0.01 parts by weight to 20.00 parts by weight, more preferably 0.05 parts by weight to 10.00 parts by weight, further preferably 0.10 parts by weight to 10.00 parts by weight, furthermore preferably 0.20 parts by weight to 5.00 parts by weight, particularly preferably 0.30 parts by weight to 4.00 parts by weight, with respect to 100 parts by weight of the thermoplastic resin (A). In a case where the contained amount of the lubricant is within the above range, the effect as a lubricant can be obtained while avoiding bleedout of the lubricant to the surface of the molded product.

### <Crystal Nucleating Agent>

The present resin composition may further contain a crystal nucleating agent. In a case where the thermoplastic resin composition contains a crystal nucleating agent and the thermoplastic resin (A) is a crystalline resin, crystallization during molding processing is promoted, and molding processability, productivity, and the like can be improved. In a case where the present resin composition contains a crystal nucleating agent, there is also an advantage that a thermoplastic resin composition excellent in heat resistance or mechanical properties and a molded product thereof can be obtained.

The crystal nucleating agent is not particularly limited, and conventionally known ones can be used. Examples of the crystal nucleating agent include inorganic substances such as talc, kaolinite, montmorillonite, mica, synthetic mica, clay, zeolite, silica, carbon black, graphite, boron nitride, zinc oxide, titanium oxide, tin oxide, calcium carbonate, magnesium carbonate, aluminum oxide, neodymium oxide, barium sulfate, sodium chloride, and metal phosphate; sugar alcohol compounds derived from natural products such as erythritol, pentaerythritol, galactitol, mannitol, and arabitol; polysaccharides such as chitin and chitosan; polyols such as aliphatic alcohol (polyol), polyvinyl alcohol, and polyethylene oxide; organic carboxylic acid metal salts such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluate, sodium salicylate, potassium salicylate, zinc salicylate, aluminum dibenzoate, potassium dibenzoate, lithium dibenzoate, sodium B-naphthalate, and sodium cyclohexanecarboxylate; organic sulfonates such as sodium p-toluenesulfonate and sodium sulfoisophthalate; carboxylic acid amides such as ethylene stearic acid amide, ethylenebis lauric acid amide, palmitic acid amide, hydroxystearic acid amide, erucic acid amide, and trimesic acid tris(t-butyl amide); carboxylic acid esters such as lauric acid ester, palmitic acid ester, oleic acid ester, stearic acid ester, erucic acid ester, N-oleyl palmitic acid ester, N-oleyl oleic acid ester, N-oleyl stearic acid ester, N-stearyl oleic acid ester, N-stearyl stearic acid ester, N-stearyl erucic acid ester, methylene bisstearic acid ester, ethylene bislauric acid ester, ethylene biscapric acid ester, ethylene bisoleic acid ester, ethylene bisstearic acid ester, ethylene biserucic acid ester, ethylene bisisostearic acid ester, butylene bisstearic acid ester, and p-xylylene bisstearic acid ester; dicarboxylic acid derivatives such as dimethyl adipate, dibutyl adipate, diisodecyl adipate, and dibutyl sebacate; cyclic compounds each having, in a molecule, a functional group C═O and one or more functional groups selected from the group consisting of NH, S, and O, such as indigo, quinacridone, and quinacridone magenta; sorbitol-based derivatives such as bisbenzylidene sorbitol and bis(p-methylbenzylidene) sorbitol; compounds each including a nitrogen-containing heteroaromatic nucleus, such as pyridine, triazine, and imidazole; phosphate ester compounds, bisamides of higher fatty acids, and metal salts of higher fatty acids; branched polylactic acids; low molecular weight poly3-hydroxybutyrate; and the like. As the crystal nucleating agent, one type may be used alone, or two or more types may be used in combination.

The contained amount of the crystal nucleating agent is not particularly limited, as long as crystallization of the thermoplastic resin (A) can be promoted. The contained amount of the crystal nucleating agent is preferably 0.05 parts by weight to 12.00 parts by weight, more preferably 0.10 parts by weight to 10.00 parts by weight, further preferably 0.50 parts by weight to 8.00 parts by weight, with respect to 100 parts by weight of the thermoplastic resin (A). In a case where the contained amount of the crystal nucleating agent is within the above range, the effect as a crystal nucleating agent can be obtained while inhibiting a decrease in viscosity during molding processing and in physical properties of the molded product.

### <Other Components>

The present resin composition may contain other components such as a plasticizer; an organic filler; an antioxidant; a hydrolysis inhibitor; an ultraviolet absorbent; coloring agents such as a dye and a pigment; and an antistatic agent, as long as the function of the obtained molded product is not impaired.

The plasticizer is not particularly limited. Examples of the plasticizer include polyester-based plasticizers such as polypropylene glycol sebacate; aliphatic dibasic acid ester-based plasticizers such as di-1-butyl adipate, di-n-butyl sebacate, and di-2-ethylhexyl azelate; glycerin-based plasticizers such as glycerin diacetomonolaurate, glycerin diacetomonocaprylate, and glycerin diacetomonodecanoate; polyvalent carboxylic acid ester-based plasticizers such as tri-2-ethylhexyl acetylcitrate and tributyl acetylcitrate; polyalkylene glycol-based plasticizers such as polyethylene glycol, polypropylene glycol, poly(ethylene oxide/propylene oxide) block and/or random copolymer, and polytetramethylene glycol; phosphoric ester-based plasticizers such as diphenyl-2-ethylhexyl phosphate and diphenyloctyl phosphate; epoxy-based plasticizers such as epoxidized soybean oil and epoxidized linseed oil fatty acid butyl ester; castor oil-based plasticizers such as castor oil fatty acid ester, methyl ricinoleate, ethyl ricinoleate, isopropyl ricinoleate, butyl ricinoleate, ethylene glycol monoricinoleate, propylene glycol monoricinoleate, trimethylolpropane monoricinoleate, sorbitan monoricinoleate, castor oil fatty acid polyethylene glycol ester, castor oil ethylene oxide adduct, castor oil-based polyol, castor oil-based toluol, and castor oil-based diol; and the like. As the plasticizer, one type may be used alone, or two or more types may be used in combination.

The organic filler is not particularly limited. Examples of the organic filler include fillers composed of naturally derived materials such as wood-based materials (for example, wood chips, wood flour, sawdust, and the like), rice husks, rice flour, starch, corn starch, rice straw, wheat straw, and natural rubber; organic fibers such as vegetable natural fibers, animal natural fibers, and synthetic fibers; and fillers composed of synthetic resin materials such as polyester, polyacrylic, polyamide, nylon, polyethylene, polyolefin, polyvinyl alcohol, polyvinyl chloride, polyurethane, polyacetal, aramid, poly-p-phenylenebenzobisoxazole (PBO), polyphenylene sulfide, acetyl cellulose, polybenzazole, polyarylate, polyvinyl acetate, and synthetic rubber.

The vegetable natural fiber is not particularly limited. Examples of the vegetable natural fiber include kenaf fiber, abaca fiber, bamboo fiber, jute fiber, hemp fiber, linen fiber, henequen (sisal hemp), ramie fiber, hemp, cotton, banana fiber, coconut fiber, palm, paper mulberry, mitsumata, bagasse, and the like. Further, regenerated fibers such as pulp processed from vegetable fibers, cellulose fibers, and rayon are also included. Examples of the animal natural fiber include wool, silk, cashmere, mohair, and the like.

The antioxidant is not particularly limited. Examples of the antioxidant include phenol-based antioxidants, phosphorus-based antioxidants, sulfur-based antioxidants, and the like. As the antioxidant, one type may be used alone, or two or more types may be used in combination.

The hydrolysis inhibitor is not particularly limited. Examples of the hydrolysis inhibitor include carbodiimide compounds, epoxy compounds, isocyanate compounds, oxazoline compounds, and the like. As the hydrolysis inhibitor, one type may be used alone, or two or more types may be used in combination.

The ultraviolet absorbent is not particularly limited. Examples of the ultraviolet absorbent include benzophenone-based compounds, benzotriazole-based compounds, triazine-based compounds, salicylic acid-based compounds, cyanoacrylate-based compounds, nickel complex salt-based compounds, and the like. As the ultraviolet absorbent, one type may be used alone, or two or more types may be used in combination.

The coloring agent such as a pigment or a dye is not particularly limited. Examples of the coloring agent include inorganic coloring agents such as titanium oxide, calcium carbonate, chromium oxide, cuprous oxide, calcium silicate, iron oxide, carbon black, graphite, titanium yellow, and cobalt blue; soluble azo pigments such as lake red, lithol red, and brilliant carmine; insoluble azo pigments such as dinitrian orange and fast yellow; phthalocyanine pigments such as monochlorophthalocyanine blue, polychlorophthalocyanine blue, and polybromophthalocyanine green; condensation polycyclic pigments such as indigo blue, perylene red, isoindolinone yellow, and quinacridone red; dyes such as oracet yellow; and the like. As the coloring agent, one type may be used alone, or two or more types may be used in combination.

The antistatic agent is not particularly limited. Examples of the antistatic agent include low molecular antistatic agents such as fatty acid ester compounds, aliphatic ethanolamine compounds, and aliphatic ethanolamide compounds, high molecular antistatic agents, and the like. As the antistatic agent, one type may be used alone, or two or more types may be used in combination.

The present resin composition may also contain a catalyst deactivator (such as hindered phenol-based compound, thioether-based compound, vitamin-based compound, triazole-based compound, polyvalent amine-based compound, hydrazine derivative-based compound, phosphorus-based compound), a release agent (such as montanic acid, a salt thereof, an ester thereof, or a half ester thereof, stearyl alcohol, stearamide, polyethylene wax), a coloring inhibitor (such as phosphite, hypophosphite), a silane coupling agent (such as epoxy silane coupling agent, amino silane coupling agent, (meth)acryl silane coupling agent, isocyanate silane coupling agent), a flame retardant (such as red phosphorus, phosphate ester, brominated polystyrene, brominated polyphenylene ether, brominated polycarbonate, aluminum hydroxide, magnesium hydroxide, melamine and cyanuric acid or a salt thereof, silicon compound), an electrically conductive agent (such as carbon black), a slidability improver (such as graphite, fluorine resin), an epoxy compound (such as glycidyl ether compound, glycidyl ester compound, polymer compound obtained by grafting or copolymerizing glycidyl compound), an acid anhydride compound (such as maleic anhydride, succinic anhydride, polymer compound obtained by grafting or copolymerizing acid anhydride), a carbodiimide compound (such as N,N′-di-2,6-diisopropylphenylcarbodiimide, 2,6,2′,6′-tetraisopropyldiphenylcarbodiimide, polycarbodiimide), or the like.

The contained amount of each of the other components described above is not particularly limited provided that the effects of an embodiment of the present invention are exhibited, and can be appropriately set by a person skilled in the art.

### <Method for Producing Thermoplastic Resin Composition>

The present resin composition can be produced by a known method. Specifically, examples thereof include a method of melt-kneading the thermoplastic resin (A), the crosslinked resin particles (B), and the inorganic filler (C), and optional components such as a crystal nucleating agent, a lubricant, and other components using an extruder, a kneader, a Banbury mixer, a kneading roller, or the like. In a case of melt-kneading, it is preferable to mix while paying attention to a decrease in molecular weight due to pyrolysis. Alternatively, the thermoplastic resin composition can be produced by dissolving all raw materials (components) in a solvent that can solve the raw materials and then removing the solvent.

In a case where the thermoplastic resin composition is produced by melt-kneading, each component may be individually introduced into an extruder or the like, or a mixture obtained by mixing components in advance may be introduced into an extruder or the like. For example, after mixing an aqueous dispersion of the thermoplastic resin (A) and an aqueous dispersion of the crosslinked resin particles (B), the obtained mixed solution may be dried with a dryer to obtain mixed powder, and the mixed powder may be introduced into an extruder or the like.

In a case where melt-kneading is carried out using an extruder, the obtained thermoplastic resin composition may be processed into a particle shape such as a bar shape, a cylindrical shape, an elliptic cylindrical shape, a spherical shape, a cubic shape, or a rectangular parallelepiped shape by extruding the thermoplastic resin composition from the extruder into a strand shape and then cutting the thermoplastic resin composition.

The resin temperature during melt-kneading cannot be unconditionally defined because the resin temperature depends on the melting point and melt viscosity of the resin used. The resin temperature is preferably 140° C. to 250° C., more preferably 140° C. to 230° C., further preferably 140° C. to 210° C., from the viewpoint of uniformly dispersing the crosslinked resin particles (B) in the thermoplastic resin (A) while avoiding pyrolysis of the thermoplastic resin (A).

### [2. Film Molded Product or Sheet Molded Product]

A film molded product or sheet molded product in accordance with an embodiment of the present invention is formed by molding a thermoplastic resin composition containing a thermoplastic resin (A) in an amount of 85.0 parts by weight to 99.0 parts by weight and crosslinked resin particles (B) in an amount of 1.0 part by weight to 15.0 parts by weight, the crosslinked resin particles (B) containing a polyhydroxyalkanoate-based resin and having a gel fraction of 50% or more, where a total amount of the thermoplastic resin (A) and the crosslinked resin particles (B) is 100 parts by weight, in which: the film molded product or sheet molded product has a thickness of 10 μm to 1000 μm; and the film molded product or sheet molded product has a drop weight impact strength of 150 mm or more.

In the present specification, the “film molded product” is in conformance with JIS20108:2012, and specifically intends a thin film-like product having a thickness of less than 0.25 mm. In the present specification, the “sheet molded product” is in conformance with JIS20108:2012, and specifically intends a thin plate-like product having a thickness of 0.25 mm or more.

The present film molded product or present sheet molded product has an advantage of being excellent in impact strength. According to a preferable embodiment of the present invention, the present film molded product or present sheet molded product also has an advantage of being excellent in balance between strength and rigidity.

The polyhydroxyalkanoate-based resin contained in the present crosslinked resin particles (B) is a biodegradable resin. Therefore, the present crosslinked resin particles (B) can have biodegradability. Since the present film molded product or present sheet molded product contains the crosslinked resin particles (B) which can have biodegradability, the present film molded product or present sheet molded product is advantageous from the viewpoint of biodegradability.

In an embodiment of the present invention, the thickness of the film molded product or sheet molded product is 10 μm to 1000 μm. In an embodiment of the present invention, the lower limit of the thickness of the film molded product or sheet molded product may be 11 μm, may be 12 μm, may be 13 μm, may be 14 μm, or may be 15 μm. In an embodiment of the present invention, the upper limit of the thickness of the film molded product or sheet molded product may be 900 μm, may be 800 μm, may be 700 μm, may be 500 μm, or may be 450 μm. In another embodiment of the present invention, the thickness of the sheet molded product may be 600 μm to 1000 μm.

In the present film molded product or present sheet molded product, it is preferable that: the thermoplastic resin composition further contains an inorganic filler (C); and in the thermoplastic resin composition, the thermoplastic resin (A) is in an amount of 40.0 parts by weight to 98.0 parts by weight, the crosslinked resin particles (B) are in an amount of 1.0 part by weight to 15.0 parts by weight, and the inorganic filler (C) is in an amount of 1.0 part by weight to 50.0 parts by weight, where a total amount of the thermoplastic resin (A), the crosslinked resin particles (B), and the inorganic filler (C) is 100 parts by weight.

In regard to each component of the present film molded product or present sheet molded product, aspects other than those described above are the same as those described in the section of [1. Thermoplastic resin composition] above, and therefore those descriptions are applied and not repeated here.

### <Method for Producing Film Molded Product or Sheet Molded Product>

The present film molded product or present sheet molded product can be produced by a known method. Specifically, examples thereof include a method of molding the thermoplastic resin composition by a molding method such as an inflation molding method, an extrusion blow molding method, an injection blow molding method, an extrusion molding method, a calender molding method, a vacuum molding method, an injection molding method, a T-die extrusion molding method, a casting method, a rolling method, or a melt pressing method. Among these, the present film molded product or present sheet molded product is preferably molded by an inflation molding method, a calender molding method, a T-die extrusion molding method, a casting method, a rolling method, or a melt pressing method. The film molded product or sheet molded product formed by molding the thermoplastic resin composition can also be said to be a film molded product or sheet molded product containing the thermoplastic resin composition.

By carrying out the above-described molding method, a molded product, specifically, a sheet molded product or a film molded product, excellent in impact strength can be produced with satisfactory productivity.

The inflation molding method refers to a molding method in which a molten resin composition is extruded into a tube shape from an extruder having a cylindrical die attached to a tip thereof, and immediately after that, a gas is blown into the tube to inflate the tube into a balloon shape, thereby molding a tubular single-layer or multilayer film.

The calender molding method refers to a molding method in which a resin raw material heated to a molten state in advance is sandwiched between a plurality of rollers and rolled to form a film or a sheet.

The T-die extrusion molding method refers to a molding method in which a thermoplastic resin composition heated to a molten state in an extruder is discharged from a T-die outlet attached to the extruder to obtain a sheet-like thermoplastic resin in a molten state, and then the sheet-like thermoplastic resin is taken up while being sandwiched between a pair of smoothing rollers to be cooled and solidified to form a film or a sheet.

By carrying out the above-described production method, a molded product excellent in impact strength such as a blow molded product, an extrusion molded product, a vacuum molded product, or an injection molded product can also be produced with satisfactory productivity, in addition to the film molded product or sheet molded product.

### <Impact Resistance Property of Film Molded Product or Sheet Molded Product>

In another embodiment of the present invention, the drop weight impact strength of the film molded product or sheet molded product is 150 mm or more, preferably 200 mm or more, more preferably 300 mm or more, further preferably 350 mm or more, particularly preferably 360 mm or more. In a case where the drop weight impact strength of the present film molded product or present sheet molded product is 150 mm or more, there is an advantage that the molded product is difficult to break because the molded product has high impact strength.

In an embodiment of the present invention, the tensile modulus of the film molded product or sheet molded product is preferably 2000 MPa or more, more preferably 2500 MPa or more, further preferably 3000 MPa or more. In a case where the tensile modulus of the present film molded product or present sheet molded product is 2000 MPa or more, there is an advantage that resistance to deformation is large and bending is difficult because the molded product has high rigidity.

The present film molded product or present sheet molded product can be suitably used in the fields of agriculture, fishery, forestry, horticulture, medicine, hygiene products, food industry, clothing, non-clothing, packaging, motor vehicles, and building materials, and other fields.

An embodiment of the present invention may have the following features.
<1> A thermoplastic resin composition containing: a thermoplastic resin (A) in an amount of 40.0 parts by weight to 98.0 parts by weight; crosslinked resin particles (B) in an amount of 1.0 part by weight to 15.0 parts by weight, the crosslinked resin particles (B) containing a polyhydroxyalkanoate-based resin and having a gel fraction of 50% or more; and an inorganic filler (C) in an amount of 1.0 part by weight to 50.0 parts by weight, where a total amount of the thermoplastic resin (A), the crosslinked resin particles (B), and the inorganic filler (C) is 100 parts by weight.
<2> The thermoplastic resin composition described in <1>, in which the polyhydroxyalkanoate-based resin is a poly(3-hydroxyalkanoate)-based resin.
<3> The thermoplastic resin composition described in <1> or <2>, in which a volume-average particle size of the crosslinked resin particles (B) is 0.10 μm to 10.00 μm.
<4> The thermoplastic resin composition described in any one of <1> through <3>, in which the crosslinked resin particles (B) are crosslinked using a peroxide.
<5> The thermoplastic resin composition described in <4>, in which the crosslinked resin particles (B) are crosslinked in the presence of the peroxide and a polyfunctional compound.
<6> The thermoplastic resin composition described in any one of <1> through <5>, in which the crosslinked resin particles (B) are not expanded.
<7> The thermoplastic resin composition described in any one of <1> through <6>, in which the thermoplastic resin (A) contains a biodegradable resin.
<8> The thermoplastic resin composition described in <7>, in which the biodegradable resin contains a polyester-based resin.
<9> The thermoplastic resin composition described in any one of <1> through <8>, further containing a crystal nucleating agent and/or a lubricant.
<10> The thermoplastic resin composition described in any one of <1> through <9>, in which a volume-average particle size of the inorganic filler (C) is 0.1 μm to 100.0 μm.
<11> The thermoplastic resin composition described in any one of <1> through <10>, in which the inorganic filler (C) is at least one selected from the group consisting of mica, talc, kaolinite, and calcium carbonate.
<12> A molded product, which is formed by molding the thermoplastic resin composition described in any one of <1> through <11>.
<13> The molded product described in <12>, in which the molded product is a sheet molded product, a film molded product, a blow molded product, an extrusion molded product, a vacuum molded product, or an injection molded product.
<14> A film molded product or a sheet molded product, which is formed by molding a thermoplastic resin composition containing a thermoplastic resin (A) in an amount of 85.0 parts by weight to 99.0 parts by weight and crosslinked resin particles (B) in an amount of 1.0 part by weight to 15.0 parts by weight, the crosslinked resin particles (B) containing a polyhydroxyalkanoate-based resin and having a gel fraction of 50% or more, where a total amount of the thermoplastic resin (A) and the crosslinked resin particles (B) is 100 parts by weight, in which: the film molded product or sheet molded product has a thickness of 10 μm to 1000 μm; and the film molded product or sheet molded product has a drop weight impact strength of 150 mm or more.
<15> The film molded product or sheet molded product described in <14>, in which the film molded product or sheet molded product has a tensile modulus of 2000 MPa or more.
<16> The film molded product or sheet molded product described in claim <14> or <15>, in which: the thermoplastic resin composition further contains an inorganic filler (C); and
in the thermoplastic resin composition, the thermoplastic resin (A) is in an amount of 40.0 parts by weight to 98.0 parts by weight, the crosslinked resin particles (B) are in an amount of 1.0 part by weight to 15.0 parts by weight, and the inorganic filler (C) is in an amount of 1.0 part by weight to 50.0 parts by weight, where a total amount of the thermoplastic resin (A), the crosslinked resin particles (B), and the inorganic filler (C) is 100 parts by weight.
<17> The film molded product or sheet molded product described in any one of <14> through <16>, in which the polyhydroxyalkanoate-based resin is a poly(3-hydroxyalkanoate)-based resin.
<18> The film molded product or sheet molded product described in any one of <14> through <17>, in which a volume-average particle size of the crosslinked resin particles (B) is 0.10 μm to 10.00 μm.
<19> The film molded product or sheet molded product described in any one of <14> through <18>, in which the crosslinked resin particles (B) are crosslinked using a peroxide.
<20> The film molded product or sheet molded product described in <19>, in which the crosslinked resin particles (B) are crosslinked in the presence of the peroxide and a polyfunctional compound.
<21> The film molded product or sheet molded product described in any one of <14> through <20>, in which the crosslinked resin particles (B) are not expanded.
<22> The film molded product or sheet molded product described in any one of <14> through <21>, in which a the thermoplastic resin (A) contains biodegradable resin.
<23> The film molded product or sheet molded product described in <22>, in which the biodegradable resin contains a polyester-based resin.
<24> The film molded product or sheet molded
product described in any one of <14> through <23>, further containing a crystal nucleating agent and/or a lubricant.
<25> The film molded product or sheet molded product described in <16>, in which a volume-average particle size of the inorganic filler (C) is 0.1 μm to 100.0 μm.
<26> The film molded product or sheet molded product described in <16>, in which the inorganic filler (C) is at least one selected from the group consisting of mica, talc, kaolinite, and calcium carbonate.
<27> The film molded product or sheet molded product described in any one of <14> through <26>, in which the film molded product or sheet molded product is formed by an inflation molding method, a calender molding method, a T-die extrusion molding method, a casting method, a rolling method, or a melt pressing method.

### EXAMPLES

The following description indicates Examples to discuss an embodiment of the present invention in more detail. Note, however, that the present invention is not limited to these Examples.

### <1> Measurement Conditions

### 1-1. Weight-Average Molecular Weight

A resin to be measured was added to chloroform, and the obtained mixture was heated in a hot water bath at 60° C. for 30 minutes. The obtained mixture (chloroform solution) was filtered through a PTFE disposable filter having a pore size of 0.45 μm. After that, GPC measurement was carried out using the obtained filtrate under the following conditions to determine the weight-average molecular weight.
GPC measuring device: High Performance Liquid Chromatograph 20A System manufactured by Shimadzu Corporation
Column: K-G 4A (one), K-806M (two) manufactured by Showa Denko K.K.
Sample concentration: 1 mg/ml
Free liquid: Chloroform solution
Free liquid flow rate: 1.0 ml/min
Sample injection amount: 100 μL
Analysis time: 30 minutes
Standard sample: Standard polystyrene.

### 1-2. Volume-Average Particle Size

The volume-average particle size of the crosslinked resin particles (B) was measured using an aqueous dispersion of the crosslinked resin particles (B) as a sample. Microtrac MT3300EXII manufactured by Nikkiso Co., Ltd. was used as s a measuring device. Specifically, using the above device, the particle size and volume of each crosslinked resin particle (B) or uncrosslinked resin particle in the aqueous dispersion of the crosslinked resin particles (B) or uncrosslinked resin particles were measured, and the volume-average particle size was calculated based on the above described formula (1), that is, formula (2), from the results obtained by the measurement.

### 1-3. Gel Fraction

A dried product of the crosslinked resin particles (B) was added to chloroform so as to have a concentration of 0.7% by weight, and maintained at 60° C. for 30 minutes to obtain a chloroform solution. Then, after leaving to stand still at room temperature for 3 hours, the chloroform solution was filtered through a membrane filter having a pore size of 0.45 μm. Loss was prevented by carrying out the filtration while sufficiently washing the inside of the container and the filter with chloroform multiple times. The gel remaining on the filter was dried, the weight was measured together with the filter, and the gel fraction was calculated by the following formula.

$$Formula : Gel fraction = ( ( weight of filter including dry get - weight of filter only ) / weight of crosslinked resin particles ( B ) used for measurement ) \times 100 ( \% ) .$$

### 1-4. Drop Weight Impact Strength

A molded product prepared by a method described later was used as a sample. The sample was cut into a 40 mm square to obtain a test piece. The test piece was subjected to a drop weight impact strength test with a 300 g drop weight using a DuPont drop impact tester (striker tip radius: 7.93 mm). First, the 300 g drop weight was dropped onto the test piece from a drop height of 100 mm. In a case where a crack or break occurred in the test piece, the drop height was lowered by 10 mm (that is, the drop height was decreased by 10 mm), and in a case where no crack or break occurred in the test piece, the drop height was raised by 10 mm (that is, the drop height was increased by 10 mm). The test piece was renewed, and the 300 g drop weight was dropped onto the test piece again. This operation was repeated, and the minimum value of the height (mm) at which the sample piece broke was determined as the drop weight impact strength (mm).

### 1-5. Tensile Modulus

A molded product prepared by a method described later was used as a sample. The sample was cut into a dumbbell shape in conformance with JIS K 7127 TYPE 5 to obtain a test piece. The test piece was subjected to a tensile test using a tensile tester (“EZ-LX 1 kN” manufactured by Shimadzu Corporation) by a method in conformance with JIS K 7127 under a condition of a tensile speed of 100 mm/min. Based on an S—S curve obtained by the tensile test, the tensile modulus (MPa) was calculated.

### 1-6. Method for Measuring Volume-Average Particle Size of Inorganic Filler

The volume-average particle size of the inorganic filler was measured by a laser diffraction method. Using a scattering type particle size distribution measuring device (“LA-9050V2” manufactured by Horiba, Ltd.) as a measuring device, the volume-average particle size was calculated under the following measurement conditions in a state where the inorganic filler was dispersed in water.

### [Measurement Conditions]

Particle refractive index: 1.59-0.11 Dispersion medium: Water Dispersion medium refractive index: 1.33

### <2> Evaluation of Polyhydroxyalkanoate-Based Resin

### 2-1. Raw Material of Crosslinked Resin Particles (B)

### 2-1-1. Uncrosslinked Resin Particles

Poly(3-hydroxybutyrate-co-3-hydroxyhexanoate): Composition of repeating units; (3-hydroxybutyrate)/(3-hydroxyhexanoate)=72/28 (mol/mol), weight-average molecular weight Mw: 500,000 to 1,500,000 The weight-average molecular weight of the resin was measured by the method described above.

### 2-1-2. Peroxide

Di-sec-butylperoxy dicarbonate (“LUPEROX (registered trademark) 225” manufactured by Arkema Yoshitomi, Ltd., 1-hour half-life temperature: 69° C.).

### 2-1-3. Polyfunctional Compound

Triallyl isocyanurate.

### 2-2. Method for Producing Crosslinked Resin Particles (B)

### Production Example

Crosslinked resin particles (B) were produced by a procedure described below. To an autoclave equipped with a stirrer, a baffle, a nitrogen inlet/outlet, and a thermometer, or a glass container, an aqueous dispersion in which uncrosslinked resin particles were dispersed in water (100 parts by weight in terms of solid content), 200 parts by weight of deionized water, 2 parts by weight of a peroxide, 1 part by weight of sodium dioctyl sulfosuccinate, and 0.5 parts by weight of a polyfunctional compound were added to prepare an aqueous dispersion. At the same time as start of stirring of the obtained aqueous dispersion at room temperature, the inside of the autoclave or the glass container was replaced with nitrogen. After that, by stirring at room temperature (25+5° C.) for 1 hour, the aqueous dispersion in the autoclave or the glass container was stirred to impregnate the inside of the uncrosslinked resin particles with the peroxide and the polyfunctional compound.

After that, the aqueous dispersion was heated to 75° C. After reaching 75° C., a reaction was carried out for 3.5 hours while maintaining the temperature to obtain an aqueous dispersion in which crosslinked resin particles (B) were dispersed in water.

The volume-average particle size and gel fraction of the obtained crosslinked resin particles (B) were measured by the methods described above. The obtained crosslinked resin particles (B) had a volume-average particle size of 1.70 μm and a gel fraction of 95%.

After adjusting pH of the aqueous dispersion, the aqueous dispersion was dried in an oven to obtain solidified crosslinked resin particles (B).

### 2-3. Raw Material of Thermoplastic Resin Composition

### 2-3-1. Thermoplastic Resin (A)

A-1: Poly(3-hydroxybutyrate-co-3-hydroxyhexanoate) (P3HB3HH) having a 3-hydroxyhexanoate (3HH) composition of 5.8 mol % and a weight-average molecular weight of 530,000, obtained according to the method disclosed in International Publication No. WO 2008/010296
A-2: Poly(3-hydroxybutyrate-co-3-hydroxyhexanoate) (P3HB3HH) having a 3HH composition of 10.5 mol % and a weight-average molecular weight of 540,000, obtained according to the method disclosed in International Publication No. WO 2013/147139

### 2-3-2. Crosslinked Resin Particles (B)

Crosslinked resin particles (B) prepared in (Production Example)

### 2-3-3. Inorganic filler (C): Mica (A-21S manufactured by Yamaguchi Mica Co., Ltd., volume-average particle size: 22 μm)

### 2-4. Method for Producing Thermoplastic Resin Composition

### Examples 1 Through 3 and Comparative Example 1

For each Example and Comparative Example, the thermoplastic resin (A), the crosslinked resin particles (B), and the inorganic filler (C) described in Table 1 were mixed in amounts indicated in Table 1 to obtain a mixture. The obtained mixture was melt-kneaded for 3 minutes at a roller rotation speed of 16 rpm with two rollers heated to 145° C. to obtain a sheet molded product having a thickness of 700 μm. The drop weight impact strength and tensile modulus of the obtained sheet molded product were evaluated. The results are shown in Table 1.

TABLE 1

| | | | | | | Comparative |
|---|---|---|---|---|---|---|
| | | | Example 1 | Example 2 | Example 3 | Example 1 |
| Thermoplastic | A-1: P3HB3HH | Parts by | 90 | 90 | 60 | 90 |
| resin (A) | | weight | | | | |
| | A-2: P3HB3HH | Parts by | 10 | 10 | 40 | 10 |
| | | weight | | | | |
| Crosslinked resin particles (B) | | Parts by | 10 | 20 | 5 | — |
| | | weight | | | | |
| Inorganic filler (C): mica | | Parts by | 60 | 60 | 35 | 60 |
| | | weight | | | | |
| Compositional | Thermoplastic resin | % by | 58.8 | 55.6 | 71.4 | 62.5 |
| ratio (% by | (A) | weight | | | | |
| weight) | Crosslinked resin | % by | 5.9 | 11.1 | 3.6 | — |
| | particles (B) | weight | | | | |
| | Inorganic filler (C) | % by | 35.3 | 33.3 | 25.0 | 37.5 |
| | | weight | | | | |

| | | | | | |
|---|---|---|---|---|---|
| Drop weight impact strength (height at | mm | 150 | 380 | 370 | 40 |
| break of test piece with 300 g drop | | | | | |
| weight) | | | | | |
| Tensile modulus | MPa | 3200 | 2450 | 3200 | 4000 |

From Table 1, it can be seen that in Examples 1 through 3 in which the crosslinked resin particles (B) were blended with the thermoplastic resin (A), although the tensile modulus decreased, the height at break was higher and thus the strength was increased and the impact strength was excellent, as compared with Comparative Example 1 in which the crosslinked resin particles (B) were not blended.

### INDUSTRIAL APPLICABILITY

According to an embodiment of the present invention, it is possible to provide a novel thermoplastic resin composition capable of providing a molded product excellent in impact strength, and to provide a film molded product or sheet molded product excellent in impact strength. Thus, an embodiment of the present invention can be suitably used in the fields of agriculture, fishery, forestry, horticulture, medicine, hygiene products, food industry, clothing, non-clothing, packaging, motor vehicles, and building materials, and other fields.

1. A thermoplastic resin composition comprising:
a thermoplastic resin (A) in an amount of 40.0 parts by weight to 98.0 parts by weight;
crosslinked resin particles (B) in an amount of from 1.0 part by weight to 15.0 parts by weight, wherein the crosslinked resin particles (B) comprise a polyhydroxyalkanoate-based resin and have a gel fraction of at least 50%, and wherein the crosslinked resin particles (B) are crosslinked in the presence of a peroxide and a polyfunctional compound; and
an inorganic filler (C) in an amount of from 1.0 part by weight to 50.0 parts by weight, where a total amount of the thermoplastic resin (A), the crosslinked resin particles (B), and the inorganic filler (C) is 100 parts by weight.

2. (canceled)

3. The thermoplastic resin composition of claim 1, wherein the thermoplastic resin (A) contains a biodegradable resin.

4. The thermoplastic resin composition of claim 3, wherein the biodegradable resin contains a polyester-based resin.

5. The thermoplastic resin composition of claim 1, wherein a volume-average particle size of the inorganic filler (C) is from 0.1 μm to 100.0 μm.

6. The thermoplastic resin composition of claim 1, wherein the inorganic filler (C) is at least one selected from the group consisting of mica, talc, kaolinite, and calcium carbonate.

7. A molded product, which is formed by molding the thermoplastic resin composition of claim 1.

8. The molded product of claim 7, wherein the molded product is a sheet molded product, a film molded product, a blow molded product, an extrusion molded product, a vacuum molded product, or an injection molded product.

9. A film molded product or a sheet molded product, which is formed by molding a thermoplastic resin composition comprising a thermoplastic resin (A) in an amount of from 85.0 parts by weight to 99.0 parts by weight and crosslinked resin particles (B) in an amount of from 1.0 part by weight to 15.0 parts by weight, wherein the crosslinked resin particles (B) comprise a polyhydroxyalkanoate-based resin and have a gel fraction of at least 50%, where a total amount of the thermoplastic resin (A) and the crosslinked resin particles (B) is 100 parts by weight,
wherein
the film molded product or sheet molded product has a thickness of from 10 μm to 1000 μm; and
the film molded product or sheet molded product has a drop weight impact strength of at least 150 mm.

10. The film molded product or sheet molded product of claim 9, wherein the film molded product or sheet molded product has a tensile modulus of at least 2000 MPa.

11. The film molded product or sheet molded product of claim 9,
wherein
the thermoplastic resin composition further comprises an inorganic filler (C);
in the thermoplastic resin composition, the thermoplastic resin (A) is in an amount of from 40.0 parts by weight to 98.0 parts by weight, the crosslinked resin particles (B) are in an amount of from 1.0 part by weight to 15.0 parts by weight, and the inorganic filler (C) is in an amount of from 1.0 part by weight to 50.0 parts by weight, where a total amount of the thermoplastic resin (A), the crosslinked resin particles (B), and the inorganic filler (C) is 100 parts by weight, and
the crosslinked resin particles (B) are crosslinked in the presence of a peroxide and a polyfunctional compound.

12. (canceled)

13. The film molded product or sheet molded product of claim 9, wherein the thermoplastic resin (A) comprises a biodegradable resin.

14. The film molded product or sheet molded product of claim 13, wherein the biodegradable resin comprises a polyester-based resin.

15. The film molded product or sheet molded product of claim 11, wherein a volume-average particle size of the inorganic filler (C) is from 0.1 μm to 100.0 μm.

16. The film molded product or sheet molded product of claim 11, wherein the inorganic filler (C) is at least one selected from the group consisting of mica, talc, kaolinite, and calcium carbonate.

17. The film molded product or sheet molded product of claim 9, wherein the film molded product or sheet molded product is formed by an inflation molding method, a calender molding method, a T-die extrusion molding method, a casting method, a rolling method, or a melt pressing method.
